(19) United States
(12) Patent Application Publication
(10) Pub. No.: US 2026/0249917 A1
(43) Pub. Date: Aug. 27, 2026

(54) SUSPENSION SYSTEM WITH PROTECTIVE COVER

(71) Applicant: FLEXIS, BOULOGNE-BILLANCOURT (FR)

(72) Inventors: Gilles ENJOLRAS, VILLIERS SAINT-FREDERIC (FR); Olivier FAUQUEUX, GUYANCOURT (FR); Aziz SARAHOUI, LE MANS (FR)

(21) Appl. No.: 19/549,377

(22) Filed: Feb. 25, 2026

(30) Foreign Application Priority Data
Feb. 27, 2025 (FR) FR2502002

(51) Int. Cl. B62D 21/15; B60G 7/00

(52) U.S. Cl. CPC B62D 21/152; B60G 7/001

(57) ABSTRACT

A suspension system for a vehicle includes a rear suspension arm and a shock absorber that is linked to the rear suspension arm by a rear articulation in such a manner that the shock absorber can pivot around an articulation axis according to a determined angular travel between two extreme angular positions, the rear articulation including a fixing rod on which the shock absorber is mounted, characterized in that it includes a protective cover that is attached to the fixing rod to protect the rear articulation in case of a rear impact.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### FIELD

The present disclosure relates to a suspension system for a vehicle, in particular for a rear axle.

### BACKGROUND

Vehicles equipped with trailing arm suspension systems are already known. Generally, for each wheel of the vehicle, the suspension system comprises a suspension arm and a shock absorber. The shock absorber includes a first end that is articulated on the suspension arm and a second end that is articulated on the body or chassis of the vehicle.

For the articulation on the suspension arm, the shock absorber includes a mounting eyelet that is mounted on a transverse shaft carried by the suspension arm. For this purpose, the suspension arm includes, for example, two radial walls through which the transverse shaft is fixed and between which the mounting eyelet is arranged.

In the case of a suspension arm located at the rear of the vehicle, for a non-steering wheel of the vehicle, it is important that the mounting eyelet, and the associated end of the shock absorber, are protected against impacts. Indeed, when the vehicle reverses, it may encounter an obstacle, such as a curb, which may be at substantially the same height as the mounting eyelet relative to the ground. This can irreparably damage the suspension arm and/or the shock absorber.

Similarly, if the rear wheel descends into a sufficiently deep hollow, this can lead to contact between the mounting eyelet and the ground, thus causing damage to the suspension arm and/or the shock absorber.

In the previously described suspension system, the mounting eyelet can be partly protected by the edges of the radial walls serving to fix the transverse shaft. However, this type of arrangement can be costly, and it uses heavy elements that penalize the mass carried by the vehicle.

### SUMMARY

An aim of the present disclosure is therefore to propose a suspension system that is lighter while being more resistant to impacts.

To this end, the present disclosure has as its object a suspension system for a vehicle including a rear suspension arm and a shock absorber that is linked to the rear suspension arm by a rear articulation in such a way that the shock absorber can pivot around an articulation axis according to a determined angular travel between two extreme angular positions, the rear articulation including a fixing rod on which the shock absorber is mounted, characterized in that it includes a protective cover that is attached to the fixing rod to protect the rear articulation in case of a rear impact, and in that the protective cover includes a main wall that extends generally in a plane parallel to the articulation axis, the main wall being provided with a notch able to receive a portion of the shock absorber in at least one of its extreme angular positions.

The suspension system according to the present disclosure is lighter than existing systems while providing effective protection against rear impacts, notably against curbs or fixed posts. The solution according to the present disclosure also allows to protect the mounting eyelet and the shock absorber when the vehicle wheel descends into a hollow or descends from a curb edge.

According to other advantageous aspects of the present disclosure, the suspension system comprises one or more of the following features, taken individually or in any technically possible combinations:

the protective cover includes a fixing flange that is formed of a radial wall element, and which includes a mounting hole traversed by the fixing rod;

the radial wall element extends toward the rear up to a rear end of the main wall;

the main wall includes, at its rear end, on the side opposite to the fixing flange, at least one protective tab that extends substantially perpendicular, relative to the general plane of the main wall;

the main wall includes two protective tabs, one of which extends in a plane substantially orthogonal to the radial wall element, and the other extends in a plane substantially parallel to the radial wall element;

the main wall includes, on the side opposite to the fixing flange, a hooking member able to retain the protective cover on the rear suspension arm, before the fixing rod is attached to the rear suspension arm;

the hooking member includes two radial flanks, each flank including at least one hook;

the protective cover is realized in one piece, preferably from stamped sheet metal or by molding in plastic material.

The present disclosure also proposes a vehicle including a suspension system according to any one of the preceding claims.

### BRIEF DESCRIPTION OF THE DRAWINGS

The present disclosure will become clearer upon reading the following description, given solely by way of non-limiting example, and made with reference to the drawings in which:

FIG. 1 is a partial side view schematically representing a vehicle suspension system equipped with a protective cover in accordance with the teachings of the present disclosure;

FIG. 2 is an axial sectional view according to the plane II-II schematically representing a part of the suspension system of FIG. 1 equipped with the protective cover;

FIG. 3 is a three-quarter rear perspective view representing the protective cover of FIG. 1;

FIG. 4 is a view, similar to that of FIG. 3 representing an alternative embodiment of the protective cover including a hooking member.

### DETAILED DESCRIPTION

In the following description, identical or similar elements will in some cases be designated by the same reference numbers.

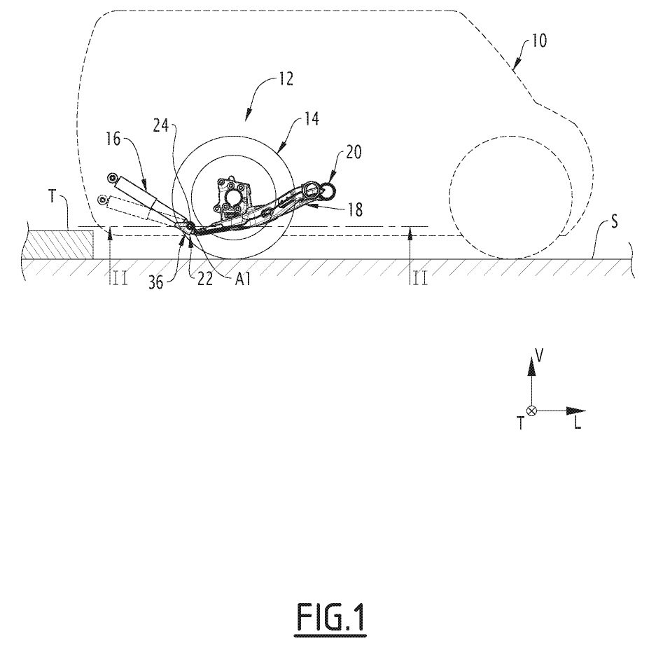

FIG. 1 represents a motor vehicle 10 provided with a suspension system 12 in accordance with the teachings of the present disclosure.

In the following description, a non-limiting orientation will be used according to a V, L, T reference frame, represented in the figures, corresponding to vertical V, longitudinal L, and transverse T directions, the longitudinal direction L corresponding to the general orientation of the vehicle 10. The longitudinal direction L is oriented here from the rear to the front, which corresponds to an orientation from left to right as considered in FIG. 1.

For illustrative purposes, only a rear wheel 14 of the vehicle 10 is represented in solid lines and only a part of the suspension system 12 arranged at the rear of the vehicle 10 is represented.

This part of the suspension system 12 includes a shock absorber 16 and a rear suspension arm 18 that are articulated on the body or on the chassis (not represented) of the vehicle 10, the rear wheel 14 being carried by the rear suspension arm 18.

The rear suspension arm 18 includes a front articulation 20 that connects the rear suspension arm 18 to the body or chassis of the vehicle 10 and a rear articulation 22 that connects the rear suspension arm 18 to the shock absorber 16.

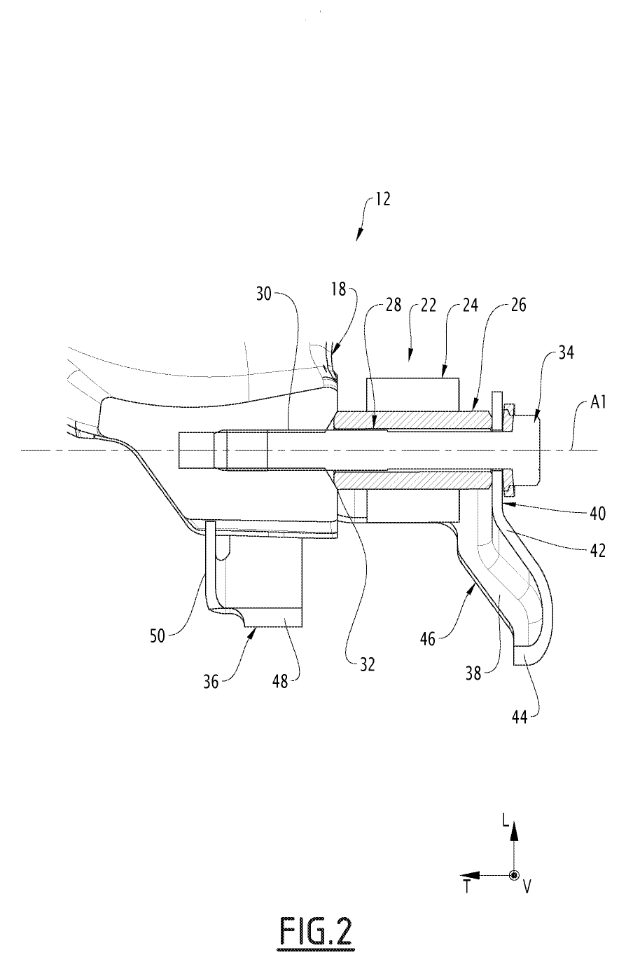

The rear articulation 22 is represented in greater detail in FIG. 2. It provides an articulation axis A1, here of transverse orientation.

The shock absorber 16 is, for example, of the hydraulic type. It includes here a mounting eyelet 24, at its lower axial end, which is articulated on a plain bearing 26 carried by the rear suspension arm 18 in such a way as to form a sliding pivot connection according to the articulation axis A1.

The plain bearing 26 is here carried by a transverse fixing rod 28 that is screwed into the rear suspension arm 18, the rear suspension arm 18 including a threaded hole 30 for this purpose. The plain bearing 26 is thus tightly mounted, according to a transverse direction, between a radial support surface 32 of the rear suspension arm 18 and a head 34 of the fixing rod 28.

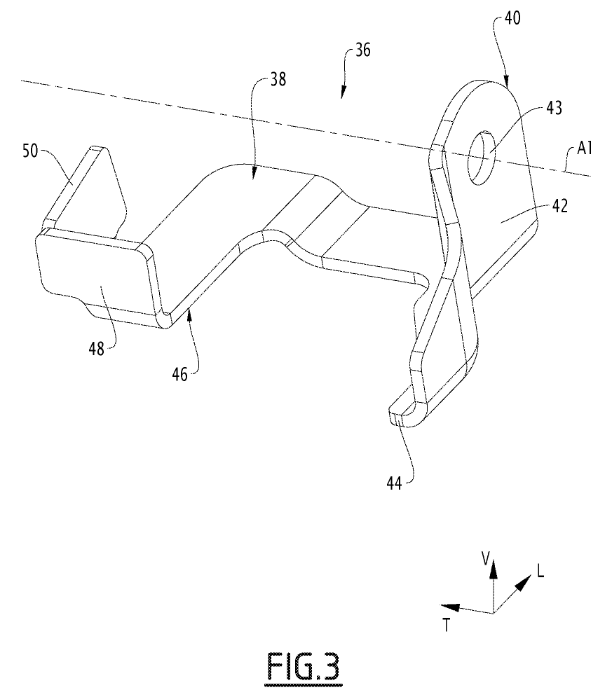

Advantageously, the suspension system 12 includes an attached protective cover 36 that is fixedly mounted on the rear suspension arm 18. This protective cover 36 is visible separately in FIG. 3.

The protective cover 36 includes a main wall 38, which extends generally in a plane parallel to the fixing rod 28 and a fixing flange 40 that allows its attachment to the rear suspension arm 18 by means of the fixing rod 28.

According to the embodiment represented, the fixing flange 40 is formed of a radial wall element 42 that is provided with a mounting hole 43 traversed by the fixing rod 28. The fixing flange 40 is here tightly mounted between the plain bearing 26 and the head 34 of the fixing rod 28.

The radial wall element 42 extends toward the rear up to a rear end 44 of the main wall 38.

The main wall 38 is provided with a notch 46, or slot, able to receive a portion of the shock absorber 16, here a portion of the main body of the shock absorber 16, when it occupies an extreme angular pivoting position, which is illustrated in dashed lines in FIG. 1.

The notch 46 here has a trapezoidal profile, as seen from above, with a rectangular side, on the side of the threaded hole 30, in other words, on the left side in FIG. 2, and a side that widens toward the rear, on the side of the head 34, in other words, on the right side in FIG. 2.

Advantageously, the main wall 38 includes, at its rear end 44, on the side opposite to the fixing flange 40, a rear protective tab 48 and a lateral protective tab 50 that are substantially orthogonal to the general plane of the main wall 38.

The rear protective tab 48 extends here in a plane substantially orthogonal to the radial wall element 42 forming the fixing flange 40.

The lateral protective tab 50 extends here in a plane substantially parallel to the radial wall element 42.

According to one alternative embodiment (not represented), the protective cover 36 could be devoid of the rear protective tab 48 or the lateral protective tab 50.

Advantageously, the protective cover 36 is realized in one piece from sheet metal, for example by folding and stamping.

According to one alternative embodiment, the protective cover 36 can be realized from a suitable plastic material by molding or 3D printing.

The installation of the protective cover 36 on the rear suspension arm 18 can be realized very simply.

For example, the plain bearing 26 and the mounting eyelet 24 can be positioned against the rear suspension arm 18, then the protective cover 36 can be positioned with its fixing flange 40 facing the threaded hole 30. It then remains to insert the fixing rod 28 through the mounting hole 43 and the plain bearing 26 by screwing it into the threaded hole 30.

Preferably, a locking washer 51 is interposed between the fixing flange 40 and the head 34 of the fixing rod 28.

The operation of the suspension system 12 and the protective cover 36 is now described, more particularly as considered in FIG. 1.

When the vehicle 10 reverses, here toward the left, the rear articulation 22 may be at the same height as an obstacle, relative to the ground S. The obstacle is, for example, a curb edge T such as schematically shown in FIG. 1.

The protective cover 36 then comes into contact, for example by its main wall 38, with the corner of the curb edge T. This not only protects the rear articulation 22 of the suspension system 12, but also helps the suspension system 12 to pass the obstacle by sliding with the main wall 38 on the corner of the curb edge T.

It is noted that, in the resting state of the suspension system 12, the main wall 38 is preferably inclined relative to the ground surface S, at an angle between 5 and 45 degrees, preferably between 10 and 30 degrees. Thus, the protective cover 36 rises toward the rear of the vehicle 10, forming a sloped surface able to slide over the obstacle when the vehicle 10 reverses.

The protective cover 36, in particular its notch 46 and its fixing flange 40, are designed to protect the entire rear articulation 22 as much as possible, in such a way as not to prevent the relative pivoting of the shock absorber body 16 relative to the rear suspension arm 18.

As illustrated in FIG. 1, the shock absorber 16 can occupy an extreme angular position, pivoted counterclockwise relative to the resting position. This extreme angular position corresponds to the case where the rear wheel 14 passes over an obstacle and rises relative to the ground surface S, which stresses the suspension system 12 upward by compressing the shock absorber 16.

In this extreme angular position, a part of the shock absorber body 16 extends through the notch 46, in other words, a part of the shock absorber body 16 passes through the general plane of the main wall 38 of the protective cover 36. This is the part of the shock absorber body 16 closest to the mounting eyelet 24.

According to another use case, when the rear wheel 14 descends into a hollow such as a rut or a gulley, the protective cover 36 also protects the rear articulation 22 from an impact against the ground surface S, or against the edges of the hollow.

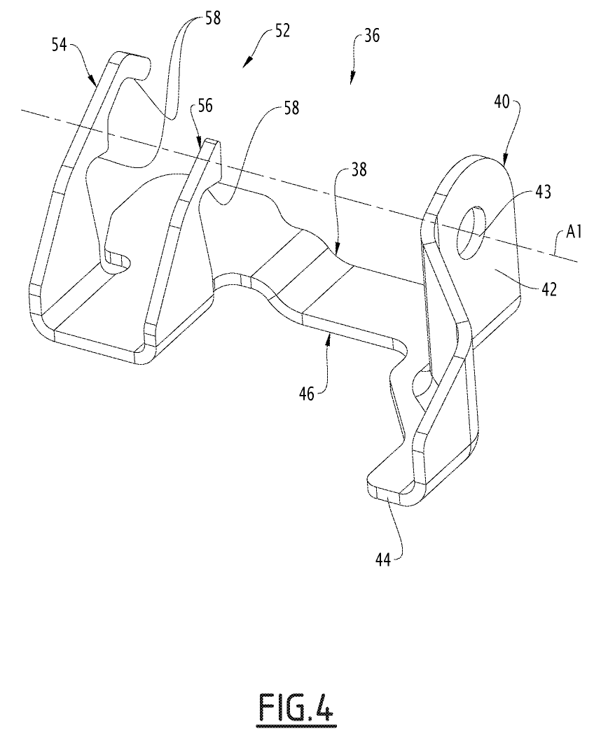

In FIG. 4, an alternative embodiment of the protective cover 36 is represented, which aims to allow pre-holding of the protective cover 36 on the rear suspension arm 18, before the installation of the fixing rod 28.

According to this alternative embodiment, the main wall 38 includes, on the side opposite to the fixing flange 40, a hooking member 52 able to retain the protective cover 36 on the rear suspension arm 18 before its attachment by means of the fixing rod 28.

According to the embodiment represented, the hooking member 52 includes a first radial flank 54 and a second radial flank 56, each radial flank 54, 56 extending upward from the main wall 38 of the protective cover 36 and including at least one hook 58.

In the example represented, each radial flank 54, 56 is obtained by folding sheet metal from an edge of the main wall 38.

The first radial flank 54, here on the left, includes two hooks 58 that adapt to the shape, in a complementary manner, of a part of the rear suspension arm 18 opposite.

The second radial flank 56, here on the right, includes a single hook 58 that also adapts to the shape, in a complementary manner, of a part of the rear suspension arm 18 opposite.

The hooking member 52 and the hooks 58 are designed and configured to allow the protective cover 36 to be held on the rear suspension arm 18, in the absence of the fixing rod 28. This allows an operator, during the assembly of the various components of the suspension system 12, to pre-position the protective cover 36 on the rear suspension arm 18 first, then independently position the plain bearing 26 and the shock absorber mounting eyelet 16, without having to simultaneously hold the protective cover 36. Once these elements are positioned, it remains only to insert the fixing rod 28 and screw it in.

Any feature described above for one embodiment or alternative is applicable to other embodiments and alternatives, as long as it is technically possible.

What is claimed is:

1. A suspension system for a vehicle comprising a rear suspension arm and a shock absorber that is linked to the rear suspension arm by a rear articulation in such a way that the shock absorber pivots around an articulation axis according to a determined angular travel between two extreme angular positions, the rear articulation comprising a fixing rod on which the shock absorber is mounted,
wherein the suspension system comprises a protective cover that is attached to the fixing rod in such a way as to protect the rear articulation in case of a rear impact, and
wherein the protective cover comprises a main wall that extends substantially in a plane parallel to the articulation axis, the main wall being provided with a notch able to receive a portion of the shock absorber in at least one of its extreme angular positions.

2. The suspension system according to claim 1, wherein the protective cover comprises a fixing flange that is formed of a radial wall, and comprises a mounting hole traversed by the fixing rod.

3. The suspension system according to claim 2, wherein the radial wall extends toward a rear of the vehicle up to a rear end of the main wall.

4. The suspension system according to claim 2, wherein the main wall comprises, at its rear end, on a side opposite to the fixing flange, at least one protective tab that extends substantially perpendicular, relative to a plane of the main wall.

5. The suspension system according to claim 4, wherein the main wall comprises two protective tabs, one of which extends in a plane substantially orthogonal to the radial wall, and the other extends in a plane substantially parallel to the radial wall.

6. The suspension system according to claim 2, wherein the main wall comprises, on a side opposite to the fixing flange, a hooking member configured to retain the protective cover on the rear suspension arm, before the fixing rod is attached to the rear suspension arm.

7. The suspension system according to claim 6, wherein the hooking member comprises two radial flanks, each flank comprising at least one hook.

8. The suspension system according to claim 1, wherein the protective cover is realized in one piece.

9. The suspension system according to claim 1, wherein the protective cover is realized in one piece from stamped sheet metal or by molding in plastic material.

10. A vehicle comprising the suspension system according to claim 1.
